(19) United States
(12) Patent Application Publication
(10) Pub. No.: US 2016/0185324 A1
(43) Pub. Date: Jun. 30, 2016

(54) MOUNTING STRUCTURE FOR OPERATION KNOB

(71) Applicants: Mitsuyuki NEDACHI, Tokyo (JP); Yasuyuki NEDACHI, Tokyo (JP)

(72) Inventor: Mitsuyuki NEDACHI, Tokyo (JP)

(21) Appl. No.: 14/745,302

(22) Filed: Jun. 19, 2015

(30) Foreign Application Priority Data
Dec. 24, 2014 (JP) 2014-259709

(51) Int. Cl. B60T 7/10; G05G 1/02; G05G 1/04; G05G 1/01

(52) U.S. Cl. CPC B60T 7/105; G05G 1/01; G05G 1/02; G05G 1/04

(57) ABSTRACT

Amounting structure for an operation knob includes: a lever shaft including at least one locking claw formed integrally with the lever shaft; and a knob to be mounted onto the lever shaft, the knob having an engagement hole to be brought into engagement with the locking claw.

### CROSS REFERENCE TO RELATED APPLICATIONS

This application is based upon and claims the benefit of priority under from the prior Japanese Patent Application No. 2014-259709, filed on Dec. 24, 2014, the entire contents of which is hereby incorporated by references.

### BACKGROUND OF THE INVENTION

1. Field of the Invention

The present invention relates to a mounting structure for an operation knob, which enables a knob to be fixed onto a lever shaft by a single operation, and to a lever shaft configured to construct the mounting structure for an operation knob.

2. Description of the Related Art

The applicant of the present invention has proposed a mounting structure for an operation knob, which is disclosed in Japanese Patent No. 3273381.

The proposal is as follows. A retainer is mounted onto a lever shaft having a circumferential groove and an anti-rotation projection formed thereon, and a shift knob is mounted onto the retainer. The retainer includes first locking claws and second locking claws. When the retainer is mounted onto the lever shaft, the second locking claws come into engagement with the circumferential groove of the lever shaft. As a result, the retainer is fixed to the lever shaft so as not to come off. In the fixed state, the anti-rotation projection of the lever shaft is fitted into an anti-rotation groove formed on the retainer, thereby regulating the rotation of the retainer about the lever shaft. Subsequently, the shift knob is mounted onto the retainer. Then, the first locking claws respectively come into engagement with engagement holes of the shift knob. In this manner, the shift knob is fixed to the retainer so as not to come off.

In general, the work of mounting the knob onto the lever shaft is preferred to be performed easier and quicker. Further, a mounting structure for an operation knob is preferred to have a simpler configuration and be more easily manufactured.

### SUMMARY OF THE INVENTION

The present invention has been made in view of the foregoing circumstances and aims to provide a mounting structure for an operation knob, which enables the work of mounting a knob onto a lever shaft to be performed easily and quickly, has a simple configuration, and is easy to manufacture.

The present invention further aims to provide a lever shaft configured to construct the mounting structure for an operation knob.

In order to solve the above-mentioned problems, according to one embodiment of the present invention, there is provided a mounting structure for an operation knob, including: a lever shaft including at least one locking claw formed integrally with the lever shaft; and a knob to be mounted onto the lever shaft, the knob having an engagement hole to be brought into engagement with the at least one locking claw.

According to the one embodiment of the present invention, by mounting the knob onto the lever shaft, the locking claw and the engagement hole come into engagement with each other. Through the engagement, the knob is fixed onto the lever shaft. In the one embodiment of the present invention, the work of mounting the knob onto the lever shaft is completed by a so-called single operation of simply mounting the knob onto the lever shaft. Therefore, the mounting work is simple and may be performed quickly. Further, only two components, which are the lever shaft including the locking claw formed integrally therewith and the knob having the engagement hole, are provided. Therefore, the mounting structure for an operation knob has a simple configuration and is easy to manufacture.

Further, according to one embodiment of the present invention, there is provided a lever shaft, onto which a knob having an engagement hole is to be mounted, the lever shaft including at least one locking claw formed integrally with the lever shaft and configured to be brought into engagement with the engagement hole to prevent the knob from coming off.

According to one exemplary embodiment of the present invention, the at least one locking claw is formed on a distal end of a claw supporting arm having elastic deformability, the claw supporting arm extending toward a distal end of the lever shaft and.

According to one exemplary embodiment of the present invention, the at least one locking claw is formed on a distal end of a claw supporting arm having elastic deformability, the claw supporting arm extending in a direction opposite to a direction toward a distal end of the lever shaft and.

### BRIEF DESCRIPTION OF THE DRAWINGS

FIG. 1 is an exploded longitudinal sectional side view of a mounting structure for an operation knob according to an embodiment of the present invention.

FIG. 2 is a longitudinal sectional side view illustrating a state in which the lever shaft and the knob illustrated in FIG. 1 are coupled to each other.

FIG. 3 is a sectional view taken along the line III-III in FIG. 2 as viewed in a direction indicated by arrows.

FIG. 4 is an exploded longitudinal sectional side view of a modified example of the mounting structure for an operation knob illustrated in FIG. 1.

FIG. 5 is a longitudinal sectional side view illustrating a state in which the lever shaft and the knob illustrated in FIG. 4 are coupled to each other.

FIG. 6 is a schematic diagram illustrating a parking brake for an automobile, as an example of a target to which the present invention is applied.

### DETAILED DESCRIPTION OF THE PREFERRED EMBODIMENTS

Now, embodiments of the present invention are described referring to the accompanying drawings.

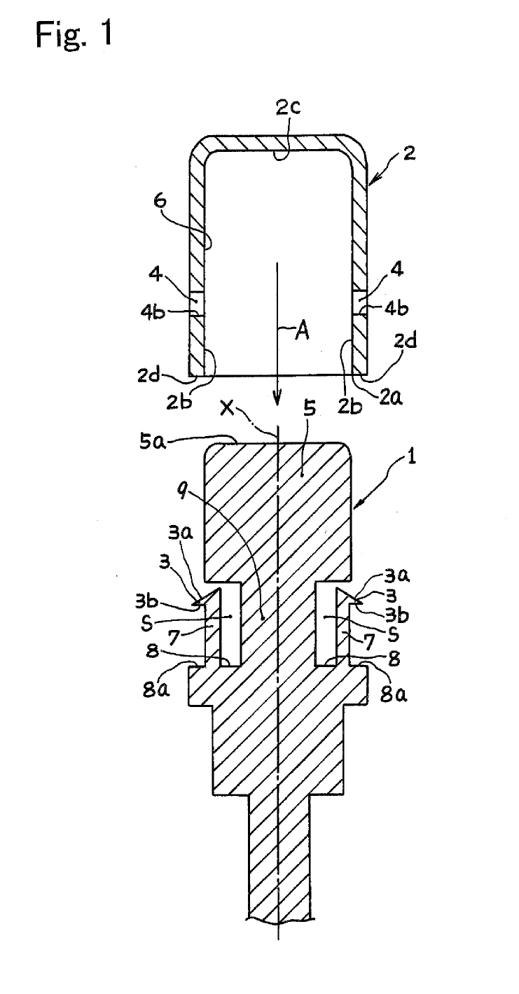

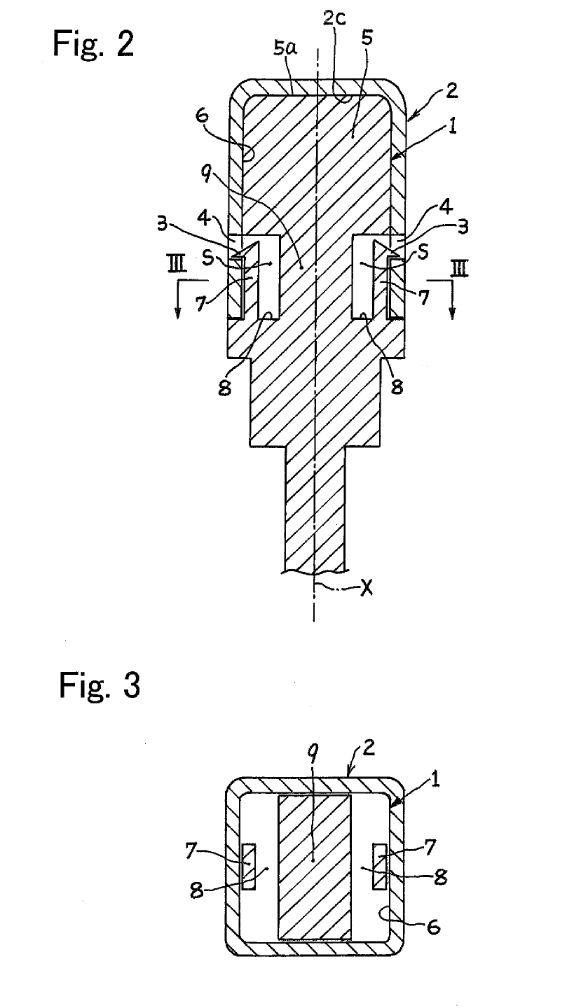

A mounting structure for an operation knob according to an embodiment of the present invention includes a lever shaft 1 and a knob 2, as illustrated in FIG. 1. The lever shaft 1 and the knob 2 are coupled to each other as illustrated in FIG. 2. Locking claws 3 and 3 are formed integrally with the lever shaft 1. Engagement holes 4 and 4 are formed through the knob 2 so as to correspond to the locking claws 3 and 3. When the knob 2 is mounted onto a head (shaft head) 5 of the lever shaft 1 in a direction indicated by the arrow A in FIG. 1, the locking claws 3 and 3 and the engagement holes 4 and 4 are brought into engagement with each other to fix the knob 2 onto the lever shaft 1 as illustrated in FIG. 2. An outer shape of the shaft head 5 may be cylindrical or rectangular cylindrical. A head fitting hole 6 having a shape corresponding to the shape of the shaft head 5 is formed in the knob 2. In an example illustrated in FIGS. 1 and 2, the outer shape of the shaft head 5 and an inner peripheral shape of the head fitting hole 6 of the knob 2 are rectangular cylindrical, as illustrated in FIG. 3.

In the following, directions such as a vertical direction (upper and lower) and a horizontal direction (right and left) are indicated based on those in FIG. 1 for convenience of description.

As illustrated in FIG. 1, the lever shaft 1 is an integrally molded piece entirely made of a resin. The locking claws 3 and 3 are formed integrally with portions of the lever shaft 1, which receive the mounting of the knob 2. The locking claws 3 and 3 prevent the knob 2 from coming off of the lever shaft 1. Therefore, only at least one locking claw needs to be formed on the lever shaft 1. In the example illustrated in FIG. 1, however, the two locking claws 3 and 3 are formed at positions opposed to each other across a central axis X of the lever shaft 1. The arrangement of the two locking claws 3 and 3 described above has an advantage in that the knob 2 can be more stably and reliably fixed to the lever shaft 1. The lever shaft 1 can be formed by, for example, injection molding using a molding die.

Each of the locking claws 3 and 3 is formed at a distal end of a claw supporting arm 7 having elastic deformability. The claw supporting arms 7 and 7 extend respectively from claw supporting surfaces 8 and 8 toward a distal end of the lever shaft 1 (upward) in parallel to the central axis X of the lever shaft 1. Each of the claw supporting surfaces 8 and 8 is a surface formed at a right angle with respect to the central axis X of the lever shaft 1. A thinned portion 9 is formed in apart of the lever shaft 1. As a result, a pair of right and left step portions are respectively formed on right and left side surfaces of the lever shaft 1. Upper surfaces of the step portions respectively become the claw supporting surfaces 8 and 8. A clearance S is formed between the thinned portion 9 and each of the claw supporting arms 7 and 7. The clearances S and S are spaces into which the locking claws 3 and 3 respectively temporarily retreat when the knob 2 is mounted. The retreating movement of the locking claws 3 and 3 is enabled by elasticity of the claw supporting arms 7 and 7.

An upper surface 3a of each of the locking claws 3 and 3 is a sloping surface 3a. When the knob 2 is mounted onto the lever shaft 1, the locking claws 3 and 3 are pressed and retreated toward the thinned portion 9 by the knob 2 due to the presence of the sloping surfaces 3a and 3a. A back surface 3b of each of the locking claws 3 and 3 is a surface formed at a right angle with respect to the central axis X of the lever shaft 1. The back surfaces 3b and 3b of the respective locking claws 3 and 3 come into abutment against hole lower surfaces 4b and 4b respectively defining the engagement holes 4 and 4 of the mounted knob 2 to prevent the knob 2 from coming off of the lever shaft 1.

The knob 2 has the head fitting hole 6 corresponding to the outer shape of the shaft head 5 of the lever shaft 1. Further, the engagement holes 4 and 4, with which the locking claws 3 and 3 of the lever shaft 1 respectively come into engagement, are formed in the knob 2 to have a rectangular-window shape. The engagement holes 4 and 4 are formed at positions at which the locking claws 3 and 3 exactly come into engagement with the engagement holes 4 and 4 when the knob 2 is fully mounted onto the shaft head 5. Similarly to the lever shaft 1, the knob 2 can be formed of, for example, a resin by injection molding using a molding die. Design properties can be enhanced by plating a surface of the knob 2.

A method of mounting the knob 2 onto the lever shaft 1 in the above-mentioned configuration is described below.

When the knob 2 is placed onto the shaft head 5 of the lever shaft 1 in the direction indicated by the arrow A as illustrated in FIG. 1, in this process, a lower end edge 2a of the knob 2 comes into abutment against the sloping surfaces 3a and 3a that are the upper surfaces of the locking claws 3 and 3. Then, by the elasticity of the claw supporting arms 7 and 7, the locking claws 3 and 3 are temporarily pressed and retreated toward the thinned portion 9. When the knob 2 is mounted more deeply, inner surfaces 2b and 2b that are located below the engagement holes 4 and 4 of the knob 2 are moved downward while sliding against the locking claws 3 and 3. When the knob 2 is fully mounted onto the shaft head 5, a vertical position of each of the locking claws 3 and 3 and that of each of the engagement holes 4 and 4 are aligned with each other. By a restoring force of the claw supporting arms 7 and 7, the locking claws 3 and 3 respectively come into engagement with the engagement holes 4 and 4. The back surfaces 3b and 3b of the respective locking claws 3 and 3 come into abutment against the hole lower surfaces 4b and 4b respectively defining the engagement holes 4 and 4 of the knob 2. As a result, the knob 2 is prevented from coming off of the lever shaft 1. A state illustrated in FIG. 2 is a state in which assembly of the knob 2 to the lever shaft 1 is completed.

A maximum mounting depth of the knob 2 with respect to the shaft head 5 is defined by the abutment between some portion of the lever shaft 1 and some portion of the knob 2. In the example illustrated in FIG. 1, an upper surface 5a of the shaft head 5 and an inner ceiling surface 2c of the knob 2 come into abutment against each other. At the same time, surfaces 8a and 8a in the claw supporting surfaces 8 and 8, which are located on an outer side of the claw supporting arms 7 and 7, come into abutment against lower end surfaces 2d and 2d of the knob 2. As a result, the maximum mounting depth of the knob 2 with respect to the shaft head 5 is defined. However, only one of the above-mentioned abutments is only needed. For example, when the maximum mounting depth of the knob 2 with respect to the shaft head 5 is defined by the abutment between the upper surface 5a of the shaft head 5 and the inner ceiling surface 2c of the knob 2, the surfaces 8a and 8a in the claw supporting surfaces 8 and 8, which are located on the outer side of the claw supporting arms 7 and 7, are not required to be formed. Further, when the maximum mounting depth of the knob 2 with respect to the shaft head 5 is defined by the abutment between the surfaces 8a and 8a in the claw supporting surfaces 8 and 8, which are located on the outer side of the claw supporting arms 7 and 7, and the lower end surfaces 2d and 2d of the knob 2, a clearance may be formed between the upper surface 5a of the shaft head 5 and the inner ceiling surface 2c of the knob 2.

According to the configuration described above, the work of mounting the knob 2 onto the lever shaft 1 is completed only by fully mounting the knob 2 onto the shaft head 5. Therefore, the mounting work is simple and can be performed quickly. Further, the number of components is only two, specifically, the lever 1 including the locking claws 3 and 3 formed integrally therewith and the knob 2 having the engagement holes 4 and 4. Therefore, the configuration is simple, while manufacture is easy. Further, component control costs can be reduced because of a small number of components.

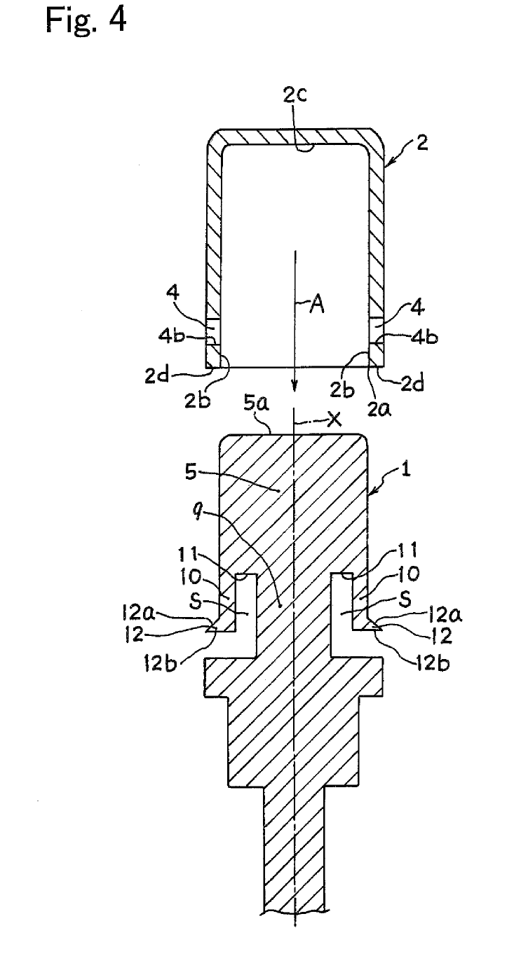

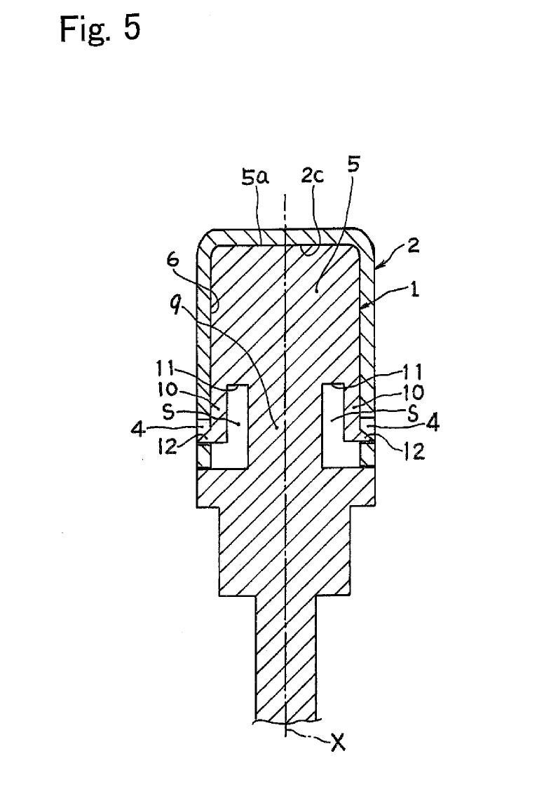

A mode illustrated in FIGS. 4 and 5 can also be used as another embodiment. In this embodiment, claw supporting arms 10 and 10 having elastic deformability extend from claw supporting surfaces 11 and 11, which are formed on the shaft head 5, in a direction opposite to the direction toward the distal end of the lever shaft 1 (downward in FIG. 4). Locking claws 12 and 12 are respectively formed on distal ends (lower ends in FIG. 4) of the claw supporting arms 10 and 10. The claw supporting arms 10 and 10 extend in parallel to the central axis X of the lever shaft 1.

Each of the claw supporting surfaces 11 and 11 is a surface formed at a right angle with respect to the central axis X of the lever shaft 1. A pair of right and left step portions are formed on the right and left side surfaces of the lever shaft 1 by forming the thinned portion 9 in a part of the lever shaft 1. Upper surfaces of the step portions are the claw supporting surfaces 11 and 11. The clearance S is formed between the thinned portion 9 and each of the claw supporting arms 10 and 10. The clearances S and S are spaces into which the locking claws 12 and 12 respectively temporarily retreat when the knob 2 is mounted. The retreating movement of the locking claws 12 and 12 is enabled by the elasticity of the claw supporting arms 10 and 10.

An upper surface of each of the locking claws 12 and 12 is a sloping surface 12a. When the knob 2 is mounted onto the lever shaft 1, the locking claws 12 and 12 are pressed and retreated toward the thinned portion 9 by the knob 2 due to the presence of the sloping surfaces 12a and 12a. A back surface 12b of each of the locking claws 12 and 12 is a surface formed at a right angle with respect to the central axis X of the lever shaft 1. The back surfaces 12b and 12b of the respective locking claws 12 and 12 come into abutment against the hole lower surfaces 4b and 4b respectively defining the engagement holes 4 and 4 of the mounted knob 2 to prevent the knob 2 from coming off of the lever shaft 1.

In the example illustrated in FIGS. 4 and 5, the locking claws 12 and 12 are formed at positions lower than those in the example illustrated in FIGS. 1 to 3. Therefore, positions of the engagement holes 4 and 4 formed in the knob 2 are correspondingly changed. The remaining configuration and mounting method are the same as those in the example illustrated in FIGS. 1 to 3. Therefore, the same reference symbols as those in FIGS. 1 to 3 are used in FIGS. 4 and 5, and the redundant description thereof is herein omitted.

It is apparent that only at least one of the locking claws 12 and 12 is required to be formed on the lever shaft 1 and only at least one of the engagement holes 4 and 4 is required to be formed in the knob 2 even in the example illustrated in FIGS. 4 and 5.

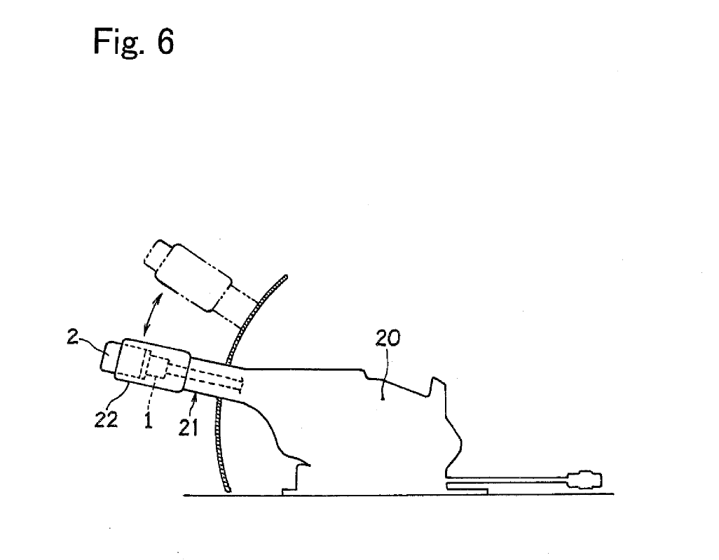

FIG. 6 is a schematic view illustrating a structure of a parking brake for an automobile. A parking brake main body 20 is arranged besides a driver's seat. The mounting structure for an operation knob according to the present invention is applied to a distal end of a handle 22 of a lever main body 21 extending from the parking brake main body 20. The lever shaft 1 is arranged inside the lever main body 21. The knob 2 is mounted onto the distal end of the lever shaft 1. The knob 2 projects beyond an opening formed on the distal end of the lever main body 21. When an automobile is stopped, a driver pulls up the handle 22 to a position indicated by the virtual line in FIG. 6. For driving the automobile, the driver performs a pushing operation on the knob 2 with a finger to unlock a lock mechanism (not shown) provided inside the parking brake main body 20 and pushes down the handle 22 to a position indicated by the solid line in FIG. 6.

In FIG. 6, a push button for the parking brake for an automobile is illustrated as an example of a target to which the mounting structure for an operation knob according to the present invention is applied. However, the application of the mounting structure for an operation knob according to the present invention is not limited thereto. It is apparent that the mounting structure for an operation knob according to the present invention can be widely applied to various types of operation levers.

What is claimed is:

1. A mounting structure for an operation knob, comprising:
a lever shaft comprising at least one locking claw formed integrally with the lever shaft; and
a knob to be mounted onto the lever shaft, the knob having an engagement hole to be brought into engagement with the at least one locking claw.

2. A lever shaft, onto which a knob having an engagement hole is to be mounted, the lever shaft comprising at least one locking claw formed integrally with the lever shaft and configured to be brought into engagement with the engagement hole to prevent the knob from coming off.

3. A mounting structure for an operation knob according to claim 1, wherein the at least one locking claw is formed on a distal end of a claw supporting arm having elastic deformability, the claw supporting arm extending toward a distal end of the lever shaft and.

4. A lever shaft according to claim 2, wherein the at least one locking claw is formed on a distal end of a claw supporting arm having elastic deformability, the claw supporting arm extending toward a distal end of the lever shaft and.

5. A mounting structure for an operation knob according to claim 1, wherein the at least one locking claw is formed on a distal end of a claw supporting arm having elastic deformability, the claw supporting arm extending in a direction opposite to a direction toward a distal end of the lever shaft and.

6. A lever shaft according to claim 2, wherein the at least one locking claw is formed on a distal end of a claw supporting arm having elastic deformability, the claw supporting arm extending in a direction opposite to a direction toward a distal end of the lever shaft and.
